(19) United States
(12) Patent Application Publication
(10) Pub. No.: US 2015/0174865 A1
(43) Pub. Date: Jun. 25, 2015

(54) REPEELABLE FOAM LAMINATE FOR ELECTRONIC DEVICE, AND ELECTRIC OR ELECTRONIC DEVICESIN FOAM AND FOAM MATERIAL

(71) Applicant: NITTO DENKO CORPORATION, Ibaraki-shi, Osaka (JP)

(72) Inventors: Itsuhiro Hatanaka, Ibaraki-shi (JP); Yusuke Yamanari, Ibaraki-shi (JP)

(73) Assignee: NITTO DENKO CORPORATION, Ibaraki-shi, Osaka (JP)

(21) Appl. No.: 14/402,787

(22) PCT Filed: Jul. 22, 2013
(86) PCT No.: PCT/JP2013/069750

§ 371 Date: Nov. 21, 2014

(30) Foreign Application Priority Data
Jul. 24, 2012 (JP) 2012-163853
Jul. 19, 2013 (JP) 2013-150398

(51) Int. Cl. B32B 27/06; B32B 27/32; B32B 5/18

(52) U.S. Cl. CPC B32B 27/065; B32B 5/18; B32B 27/32; B32B 2250/02; B32B 2307/72; B32B 2307/30; B32B 2457/00

(57) ABSTRACT

A repeelable foam laminate for use of an electronic device has a structure in which a layer containing a polyolefin-based resin is laminated to at least one surface of a foam layer, and surface roughness Sa of the layer containing a polyolefin-based resin is no more than 10 micrometers.

### TECHNICAL FIELD

The present invention relates to a repeelable foam laminate for use in relation to an electronic device, and to related types of electric or electronic devices.

### BACKGROUND ART

Typically, a gasket material is used by punching a resin foam into a window-frame shape on the periphery of a mobile device display unit such as a mobile telephone, digital camera, or the like. In recent years, due to the need for reducing the size and profile and imparting water resistance to such mobile devices, there is a demand for a resin foam that exhibits high water resistance even in a narrow width configuration.

In contrast, a method for enhancing the water resistance of a foam is known in which a resin layer that exhibits adhesive characteristics or a flexible layer is provided on the surface of the foam (see Patent Documents 1 and 2). In addition, there have been proposals in relation to a foam that is provided with a highly water soluble layer (polyvinyl alcohol layer, or the like) on the surface of the foam (see Patent Document 3), and a foam in which the surface of the foam is processed using a polychloroprene-based adhesive composition (see Patent Document 4).

However, when a flexible layer or the like as described above is formed on the foam, a heating and drying process is required, and this feature therefore results in the possibility that a foam or the like, that exhibits low density and low thermal resistance, will contract during a drying process.

In addition, even when the setting of the heating temperature is low, long term heating for a period of several to 10 days is required and therefore results in complication of the manufacturing process, and increases manufacturing costs.

Furthermore, a method not requiring a heating process has been proposed in which a thermoplastic elastomer is coextruded onto a polyolefin-based resin foam layer (see Patent Document 5). However, this method is associated with problems with water resistance due to the presence of a plurality of asperities on the surface of the resin foam layer.

Another method has been proposed in which a hot melt resin is coated onto the foam surface (see Patent Document 5). However this method exhibits a high possibility that the hot melt resin surface after cooling will be extremely hard as a result of the addition of a large amount of a highly crystalline resin, and will result in cracking in layers when subjected to bending or the like.

It can also be proposed to use an acrylic-based adhesive layer that exhibits high adhesive strength. However there is the problem that there are difficulties associated with reworking characteristics when adhering onto an electric or electronic device.

### PRIOR ART DOCUMENTS

[Patent Documents]

[Patent Document 1] JPH9-131822A

[Patent Document 2] JP2002-309198A

[Patent Document 3] JPH10-37328A

[Patent Document 4] JPH5-24143A

[Patent Document 5] JP2009-184181A

[Patent Document 6] JP2004-284575A

### DISCLOSURE OF THE INVENTION

### Problem to be Solved

The present invention has the object of providing a foam laminate that exhibits superior water resistance by laminating a layer that includes a specific polyolefin-based resin onto one surface of the foam layer.

### Means for Solving the Problem

The present inventions include inventions described below.

(1) A repeelable foam laminate for use of an electronic device has a structure in which a layer containing a polyolefin-based resin is laminated to at least one surface of a foam layer, and surface roughness Sa of the layer containing a polyolefin-based resin is no more than 10 micrometers.

(2) The repeelable foam laminate for use of an electronic device according to (1), wherein apparent density of the foam layer is 0.02 to 0.20 g/cm³, and

180-degree adhesive strength of the layer containing a polyolefin-based resin is no more than 1.0 N/20 mm with respect to an acrylic plate, and

shear adhesive strength is at least 5 N/20×10 mm.

(3) The repeelable foam laminate for use of an electronic device according to (1) or (2), wherein the layer containing a polyolefin-based resin does not deform in an atmosphere of 100 degrees C.

(4) The repeelable foam laminate for use of an electronic device according to any one of (1) to (3), wherein the crystal melting energy of the layer containing a polyolefin-based resin is no more than 50 J/g.

(5) The repeelable foam laminate for use of an electronic device according to any one of (1) to (4), wherein the polyolefin-based resin is an olefin-based resin containing a structural unit derived from propylene.

(6) An electronic or electrical device being used the repeelable foam laminate for use of an electronic device according to any one of (1) to (5).

### Effect of the Invention

The present invention provides a foam laminate that exhibits superior water resistance, and related types of electric or electronic devices.

### BRIEF DESCRIPTION OF THE DRAWINGS

FIG. 1A is a perspective view illustrating the shape of an evaluation sample that is used when evaluating the waterproof property of a foam laminate of the present invention.

FIG. 1B is a perspective view illustrating an evaluation container for waterproof property evaluation that includes assembly of the evaluation sample.

FIG. 2 is a DSC curve of the foam laminate of Examples 1 of the present invention.

### DESCRIPTION OF EMBODIMENTS

The foam laminate of the present invention principally includes a foam layer formed from resin, and a layer containing a polyolefin-based resin that is laminated onto at least one surface of the foam layer. The layer containing a polyolefin-based resin can be laminated onto both the front and the back surfaces of the foam layer, or the layer containing a polyolefin-based resin can be laminated onto one surface, and one of various known layers such as an adhesive layer, film layer, or the like can be laminated onto the other surface. In particular, when an adhesive layer is laminated onto the other surface, the foam laminated can be fixed or temporarily attached to the adherend.

The shape of the foam laminate of the present invention may include any of agglomerated shape, sheet shape, film shape, tape shape, or the like.

The foam laminate can be processed into a desired shape according to a use as an electric or electronic device, apparatus, housing, component, or the like during use.

The foam laminate of the present invention exhibits superior repeelable characteristics as a result of the provision of a layer containing a specific polyolefin-based resin on one surface thereof. In the present application, the term “repeelable” denotes a property in which peeling is facilitated without production of a contaminant onto the adherend or rupture of the foam laminate when a foam laminate, that is attached to an adherend, is peeled from the adherend. The provision of superior repeelable characteristics enables disassembly after application onto an electric or electronic device or the like without rupture of the foam laminate during a malfunction or repair. Therefore, replacement or removal operations are facilitated in relation to high value components such as LCDs, circuit boards, or the like. As a result, reworking characteristics can be remarkably enhanced. In addition to superior repeelable characteristics, superior flexibility and superior initial adhesive characteristics are exhibited at the same time.

### Layer Containing Polyolefin-Based Resin

The layer containing a polyolefin-based resin can include a polyolefin-based resin as a material used to configure the layer. Although there is no particular limitation on the content of the polyolefin-based resin in the polyolefin-based adhesive layer, preferably, it is an amount of 60 to 100 wt %, with 80 to 100 wt % being more preferred, relative to the total weight of the layer containing a polyolefin-based resin.

The layer containing a polyolefin-based resin can contain one type of polyolefin-based resin, or can contain two or more types of polyolefin-based resin.

In addition, a resin or additive or the like other than a polyolefin-based resin can be included within a range that has no adverse effect on the effect of the present invention. The layer containing a polyolefin-based resin can be a single layer, or can be configured with a laminate structure of layers that exhibit different compositions.

Examples of the polyolefin-based resin include low-density polyethylenes, medium-density polyethylenes, high-density polyethylenes, linear low-density polyethylenes, polypropylenes, copolymers of ethylene and propylene, copolymers of ethylene and another alpha-olefin, copolymers of propylene and another alpha-olefin, and copolymers of ethylene, propylene and another alpha-olefin, and copolymers of ethylene and another ethylenic unsaturated monomer. Any copolymers such as random co-polymer or block co-polymer can be used. The copolymer can be used alone or in combination of two or more.

Examples of the alpha-olefin include 1-butene, 1-pentene, 1-hexene, 1-heptene, 1-octene, 4-methyl-1-pentene, 4-methyl-1-hexene. Of these, 1-butene, 1-hexene, 1-octene, and 4-methyl-1-pentene is preferred for the alpha-olefine.

Examples of the ethylenic unsaturated monomer include vinyl acetate, acrylic acid, an acrylic acid ester, methacrylic acid, a methacrylic acid ester, vinyl alcohol, or the like.

In light of thermal resistance and flexibility, the polyolefin-based resin is preferably polypropylene (propylene homopolymer), a copolymer of ethylene and propylene, and a polypropylene-based resin containing constituent units that derived from propylene such as a copolymer of propylene and another alpha-olefin.

The layer containing a polyolefin-based resin preferably exhibits a surface roughness Sa of no more than 10 micrometers, more preferably no more than 9 micrometers, and still more preferably no more than 8 micrometers. When the surface roughness Sa is set in this range, superior slight adhesion is imparted to the adherend in the electric or electronic device. In particular, the surface of a member that configures such types of devices includes a flat and smooth metal member or insulating member, and when the layer containing a polyolefin-based resin that has a surface roughness Sa as described above is brought into contact with the flat and smooth surface, an arrangement is enabled that is adsorbed at a suitable position, and that arrangement can be maintained. In addition, when foam laminate that is provided with a layer containing a polyolefin-based resin in the above configuration is applied an electric or electronic device, it is possible to increase the contact surface area in the interface between the foam laminate and the member of the electric or electronic device to which the foam laminate is adhered, and thereby to impart superior water resistance. In particular, superior water resistance can be maintained even in a narrow width configuration in which the foam laminate has dimensions of several mm, several hundred micrometers, or several tens of micrometers.

The surface roughness Sa is a so-called three dimensional arithmetic average roughness Sa, and is calculated by expanding the two dimensional surface roughness Ra to three dimensions, and dividing the volume of the portion enclosed by the average surface and the surface contour by the measured surface area. The arithmetic average roughness Sa is calculated using the formula below. When the height z(xk, ly) using a k-th value of x and an 1-th value of y in a surface contour measured using a surface in the XY plane and a height direction as the Z axis, the following formula can be written.

$${S}_{a} = \frac{1}{MN} {\sum }_{k = 0}^{M - 1} {\sum }_{l = 0}^{N - 1} \vert z ( {x}_{k} \cdot {y}_{l} ) - μ \vert$$

Wherein; μ denotes the average surface calculating using the following formula.

$$μ = \frac{1}{MN} {\sum }_{k = 0}^{M - 1} {\sum }_{l = 0}^{N - 1} z ( {x}_{k} , {y}_{l} )$$

This surface roughness Sa can be measured using a commercially available surface contour measuring apparatus. For example, such an apparatus includes Zygo NewView 7300 (manufactured by Canon Inc.), a three dimensional non-contact surface contour measurement system (Micromap 537N-M100, manufactured by Ryoka Systems Inc.), or SURTEST SV series (manufactured by Mitutoyo Corporation).

The 180-degree adhesive strength of the layer containing a polyolefin-based resin (peel angle: 180 degrees, rate of pulling: 0.3 m/min) with respect to an acrylic plate is preferably no more than 1.0 N/20 mm, more preferably no more than 0.9 N/20 mm, and still more preferably no more than 0.8 N/20 mm. The provision of such slight adhesion imparts enhanced reworking characteristics, and effectively prevents production of a contaminant onto various adherends by the layer containing a polyolefin-based resin.

The shear adhesive strength of the layer containing a polyolefin-based resin (speed of pulling: 0.3 m/min) is preferably 5 N/20×10 mm or greater, more preferably 10 N/20×10 mm or greater, and still more preferably 15 N/20×10 mm or greater. The setting of the shear adhesive strength in this range prevents production of lateral slip of the foam laminate relative to the adherend, and enables disposition of the foam laminate to a suitable position. The unit “N/20×10 mm” means a shear adhesive strength (N) on a contact surface area having a width of 20 mm and a length of 10 mm.

The shear adhesive strength is calculated by, for example, lining the foam layer side of the foam laminate that is formed from a foam layer and in which one surface of the foam layer is provided with the layer containing the polyolefin-based resin of the present invention with an adhesive tape; preparing a measurement sample by cutting to a size having dimensions of width 20 mm and length 100 mm; adhering the measurement sample in accordance with an adhering method as disclosed in JIS Z 0237:2009 under conditions of ambient temperature (23 degrees±2 degrees C.) and humidity of 65±5% RH, that is to say, adhering the measurement sample onto an acrylic plate by being pressed using a method of a single complete stroke with a roller having a weight of 2 kg onto the adhesion surface area of 20 mm width and 10 mm length so as to bring the layer containing the polyolefin-based resin into contact with the acrylic plate; leaving for 0.5 hours at 23 degrees±2 degrees C.; after 0.5 hours elapses, measuring the weight (maximum weight), during pulling with a speed of pulling: 0.3 m/min the foam layer under conditions of 23 degrees±2 degrees C. and humidity of 65±5% RH, that is exerted in a direction parallel to the surface of the foam laminate.

The repeelable foam laminate for use in relation to an electronic device of the present invention as described above is configured to maintain slip prevention and reworking characteristics as a result of slight adhesion since the layer that is imparted with a specific surface roughness by a specific material further includes the 180-degree adhesive strength and the shear adhesive strength as described above.

The layer containing a polyolefin-based resin contains a polyolefin resin that has preferably a crystal melting energy of no more than 50 J/g, more preferably less than 50 J/g or no more than 45 J/g, still more preferably no more than 40 J/g, and further still more preferably no more than 30 J/g. It contains a polyolefin resin that has preferably no less than 10 J/g. Hereinafter the polyolefin resin having a crystal melting energy of no more than 50 J/g can be referred to as “polyolefin A”.

The polyolefin-based resin A that includes the above type of crystal melting energy is a so-called non-crystalline polyolefin resin that includes almost no crystal structure. The layer containing a polyolefin-based resin can be imparted with flexibility by setting the crystal melting energy to the above range, and thereby does not have an adverse effect on the gasket characteristics that are typical of a foam, that is to say, without an adverse effect on flexibility, compressibility, and tracking characteristics. As a result, when the foam laminate is deformed, formation of cracking in that layer can be prevented. Furthermore, it is possible to maintain repeelable characteristics and slight adhesion in that layer. In addition, production of a gap in response to an impact onto the foam laminate can be avoided, and it is possible to maintain dust resistance characteristics, and in particular dynamic dust resistance characteristics (dust resistance characteristics under a dynamic environment).

The crystal melting energy is a heat of fusion (J/g) that is calculated during a second heating by melting a sample by application of heating with a temperature increase speed of 10 degrees C/min (first heating), then decreasing the temperature of the sample to −50 degrees C. to cool at a temperature decrease speed of 10 degrees C/min (first cooling), and increasing the temperature from a temperature of −50 degrees C. by heating with a temperature increase speed of 10 degrees C/min (the second heating) to thereby measure the differential scanning calorimetry. The differential scanning calorimetry during calculation of the crystal melting energy is based on the standard set forth in JIS K 7122:1987 (plastic transition heat measurement method).

A non-crystalline polyolefin-based resin such as polyolefin A can be confirmed by a solubility test in n-heptane. More specifically, a concentration of 10 wt % of a non-crystalline polyolefin-based resin is dissolved in n-heptane, and the solubility is measured. At that time, substantially complete solubility is taken to be 100%, and a solubility of at least 90% is taken to be a non-crystallinity.

The polyolefin A is preferably a configuration as a polyolefin (metallocene-type polyolefin) that is polymerized by use of a metallocene as a catalyst in order to maintain low levels of contaminating characteristics. Because it is believed to impart resistance to bleeding of the low weight molecular components and to cause contamination since the polyolefin that is obtained by polymerization of monomer components by use of a metallocene catalyst has a narrow molecular weight distribution. The metallocene catalyst is a homogeneous catalyst, therefore, a polymer with a uniform molecular weight and composition is obtained by use of the metallocene catalyst.

The metallocene catalyst is known as a biscyclopentadienyl metallic complex [chemical formula: (C₅H₅)-M-(C₅H₅), M=Cr, Fe, Co, Ni, Zr, Ti, V, Mo, W, Zn] that is configured by two cyclopentadiene rings and a transition metal. Although there is no limitation in relation to the metallocene catalyst, the metallocene catalyst is particularly preferred one in which the transition metal is zirconium.

The polyolefin A include, for example, brand name “Tafthren™ H5002” manufactured by Sumitomo Chemical Co., Ltd., polypropylene-based elastomer, crystal melting energy: 11.3 J/g, density: 0.86 g/cm³; brand name “NOTIO™ PN20300” manufactured by Mitsui Chemicals, Inc., polypropylene-based elastomer, crystal melting energy: 23.4 J/g, density: 0.868 g/cm³; brand name “NOTIO™ PN3560” manufactured by Mitsui Chemicals, Inc., polypropylene-based elastomer, crystal melting energy: 16.9 J/g, density: 0.868 g/cm³; brand name “Licocen PP1502” manufactured by Clariant Inc., polypropylene-based wax, crystal melting energy: 26.0 J/g, density: 0.87 g/cm³; brand name “Licocen PP1602” manufactured by Clariant Inc., polypropylene-based wax, crystal melting energy: 26.9 J/g, density: 0.87 g/cm³; and brand name “Licocen PP2602” manufactured by Clariant Inc., polypropylene-based wax, crystal melting energy: 39.8 J/g, density: 0.89 g/cm³, which can be utilized as a commercial product.

Although there is no particular limitation in relation to the density of the polyolefin A, a density of 0.84 to 0.89 g/cm³ is preferred, with 0.85 to 0.89 g/cm³ being more preferred. The above density enables maintenance of flexibility and slight adhesion in the resin, and enables maintenance of molding characteristics and heat resistance.

The layer that contains a polyolefin-based resin according to the present invention preferably contain a polyolefin resin that has a crystal melting energy of more than 50 J/g in addition to the above described polyolefin A.

The polyolefin-based resin having such crystal melting energy is a so-called crystalline polyolefin resin that includes many crystal structure. Hereinafter the polyolefin resin having a crystal melting energy of more than 50 J/g can be referred to as “polyolefin B”.

Heat resistance is enhanced in addition to the above characteristics such as repeelable characteristics by inclusion of such polyolefin-based resin B.

The polyolefin B include, for example, brand name “Hi-WAX™ NP055” manufactured by Mitsui Chemicals, Inc., polypropylene-based wax, crystal melting energy: 89.1 J/g, density: 0.90 g/cm³, which can be utilized as a commercial product.

Although there is no particular limitation in relation to the density of the polyolefin B, a density of 0.90 to 0.91 g/cm³ is preferred. The polyolefin having the above density is easily obtained and enables maintenance of heat resistance of the resin.

When the polyolefin-based resin B in addition to the polyolefin-based resin A are contained in the layer that contains a polyolefin-based resin according to the present invention, the content of the polyolefin A is preferably at least 50 wt %, more preferably at least 60 wt %, and still more preferably at least 70 wt % relative to the total weight of the layer that contains a polyolefin-based resin. The content of the polyolefin B is preferably 3 to 30 wt %, more preferably 4 to 28 wt %, and still more preferably 5 to 25 wt % relative to the total weight of the layer that contains a polyolefin-based resin. When the ratio of the polyolefin B falls within the above range, the flexibility of the layer that contains a polyolefin-based resin can be maintained, and heat resistance can be maintained without an adverse effect on the flexibility or slight adhesion of the foam laminate. In addition, it is possible to enhance dust resistance characteristic (in particular dynamic dust resistance characteristics). Still furthermore, it is possible to maintain the strength of the layer that contains a polyolefin-based resin and thereby prevent embrittlement.

In other words, the layer containing a polyolefin-based resin can include a polyolefin-based resin other than the polyolefin-based resin A described above. However it is preferred that the polyolefin-based resin that configures the layer containing a polyolefin-based resin overall is configured to exhibit a crystal melting energy of preferably no more than 50 J/g, a crystal melting energy of more preferably no more than 45 J/g, and a crystal melting energy of preferably no less than 10 J/g.

The layer containing a polyolefin-based resin according to the present invention preferably does not deform in an atmosphere of 100 degrees C., more preferably does not deform in an atmosphere of 110 degrees C., and still more preferably does not deform in an atmosphere of 120 degrees C. “Deformation” as used herein denotes a feature of a change in shape only due to an ambient temperature without the addition of a special stress and that results in the partial or complete melting of the layer that contains a polyolefin-based resin, and a feature of a change in shape due to an applied stress and the maintenance of that shape change.

That is to say, the layer that contains a polyolefin-based resin preferably exhibits a melting point and softening point of more than 100 degrees C. (complying with JIS K 2207:2006), more preferably exhibits a melting point and softening point of more than 110 degrees C., and still more preferably exhibits a melting point and softening point of more than 120 degrees C.

In this manner, particularly preferred flexibility can be imparted to the layer that contains a polyolefin-based resin by provision of a specific crystal melting energy and/or a specific property of not deforming. In addition heat resistance can be maintained. As a result, suitable repeelable characteristics and slight adhesion can be maintained. Since formation is enabled without use of a solvent, environmentally friendly characteristics can be imparted. Furthermore it is possible to prevent the occurrence of hazing due to residual solvent.

The layer that contains a polyolefin-based resin according to the present invention can contain, in a range that does not impede the effect of the present invention, additives such as a tackifier (tackifying resin), highly crystalline resin additives, anti-oxidants, anti-ageing agents, plasticizer, colorants, fillers, and other resins (resins other than polyolefin-based resin A and polyolefin-based resin B). The additives can be used singly or in combinations of two or more. Additives that are known in this field can be used.

The tackifier for example includes use of a configuration having a softening point of 70 to 180 degrees C., preferably 80 to 160 degrees C., and more preferably 90 to 150 degrees C. that complies with JIS K 2207:2006. This type of tackifier includes aliphatic-based petroleum resins, fully hydrogenated aliphatic-based petroleum resins, partially hydrogenated aliphatic-based petroleum resins, aromatic-based petroleum resins, fully hydrogenated aromatic-based petroleum resins, partially hydrogenated aromatic-based petroleum resins, or the like.

When a tackifier is included in the layer that contains a polyolefin-based resin, the content of the tackifier is no more than 30 parts by weight, preferably 1 to no more than 25 parts by weight, and more preferably 3 to no more than 20 parts by weight to 100 parts by weight of the polyolefin-based resin that is contained in the layer that contains a polyolefin-based resin. This range makes it possible to maintain adhesive characteristics which is to give only a slight adhesion and can be expected to enhance dust resistance characteristics and water resistance.

The highly crystalline resin additive for example includes a crystalline low molecular weight resin such as polypropylene, polyethylene, a copolymer of those resins with an alpha-olefin or the like. The molecular weight range is a number average molecular weight of 500 to 50000, preferably 700 to 30000, and more preferably 1000 to 10000. In this context, the number average molecular weight for example is calculated as a value measured using gel permeation chromatography (GPC) in polystyrene as a molecular weight reference substance.

When the layer that contains a polyolefin-based resin includes a highly crystalline resin additive, the content thereof is preferably no more than 50 parts by weight, more preferably 1 to no more than 30 parts by weight, and still more preferably 10 to 25 parts by weight to 100 parts by weight of the polyolefin-based resin that is contained in the layer that contains a polyolefin-based resin. This range makes it possible to enhance the cohesion force of the resin, and prevents fracture of the layer that contains a polyolefin-based resin during re-peeling without adversely affecting the flexibility of the foam laminate.

There is no particular limitation on the thickness of the layer that contains a polyolefin-based resin, and it is preferably 1 to 50 micrometers, and more preferably 2 to 40 micrometers. When the thickness is configured in this manner it is possible to sufficiently maintain adhesive characteristics in relation to an adherend and the foam laminate along with enabling maintenance of the flexibility of the foam laminate.

### Foam Layer

There is no particular limitation in relation to the foam layer of the present invention as long as use is made of a gasket material or the like generally applied in relation to types of electronic or electric devices, and the layer can take any shape. The shape of the foam layer for example includes an agglomerated shape, sheet shape, film shape, or the like.

The foam layer normally has a cell (air bubble) structure. The cell structure includes any of a closed-cell structure, a semi-open semi-closed cell structure (a cell structure that is configured as a mixture of a closed-cell structure and an open-cell structure, and in which there is no particular limitation in relation to the proportion of the closed-cell structure and the open-cell structure), and an open-cell structure. In particular, the foam layer preferably includes an open-cell structure or semi-open semi-closed cell structure in order to impart superior flexibility. The semi-open semi-closed cell structure for example includes a cell structure in which the closed-cell structure in the cell structure is no more than 40% (volume %) (preferably no more than 30% (volume %)).

The apparent density of the foam layer can be appropriately set according to the purpose of use, and is preferably 0.02 to 0.20 g/cm³, more preferably 0.03 to 0.17 g/cm³, and still more preferably 0.04 to 0.15 g/cm³. This density ensures flexibility as a result of sufficient foaming, and ensures the strength of the foam layer.

The density of the foam layer is calculated as shown below.

A punch cutting die having dimensions of 40 mm×40 mm is used to punch the foam layer into a punched sample, and the dimensions (vertical, horizontal) are measured. The thickness of the sample is measured using a 1/100 dial gauge which is a measurement terminal having a diameter of (φ) 20 mm. The volume of the sample is calculated using the value for the thickness of the sample and the dimensions of the sample. Then, the weight of the sample is measured using a balance to at least the smallest scale of 0.01 g. The values for the volume of the sample and the weight of the sample are used to calculate the density (g/cm³)

There is no particular limitation to the thickness of the foam layer, and for example, a thickness of 0.1 to 5 mm is preferred and 0.2 to 3 mm being more preferred in light of dust resistant characteristics and impact absorption characteristics, and furthermore in light of applicability to an electronic or electric device that has a shape such as a thin, small, slender or the like.

The foam layer is configured from resin. There is no particular limitation in relation to the resin used to configure the foam layer as long as it exhibits thermoplastic characteristics and is a resin that is configured to enable impregnation with a gas (a gas for the formation of cells). A thermoplastic resin is preferred. The foam layer can be configured from a single type of resin, or can be configured from two or more types of resin.

Examples of the thermoplasticity resin include olefinic polymers such as low-density polyethylenes, medium-density polyethylenes, high-density polyethylenes, linear low-density polyethylenes, polypropylenes, copolymers between ethylene and propylene, copolymers between ethylene or propylene and another alpha-olefin (e.g., butene-1, pentene-1, hexene-1,4-methylpentene-1, or the like), and copolymers between ethylene and another ethylenically unsaturated monomer (e.g., vinyl acetate, acrylic acid, an acrylic acid ester, methacrylic acid, a methacrylic acid ester, or vinyl alcohol); styrenic polymers such as polystyrenes and acrylonitrile-butadiene-styrene copolymers (ABS resins); polyamides such as 6-nylon, 66-nylon, and 12-nylon; polyamideimides; polyurethanes; polyimides; polyetherimides; acrylic resins such as polymethyl methacrylate; polyvinyl chloride; polyvinyl fluoride; alkenyl aromatic resins; polyesters such as polyethylene terephthalate and polybutylene terephthalate; polycarbonates such as bisphenol-A polycarbonates; polyacetals; and polyphenylene sulfide. These can be used alone or in combination. When the thermoplasticity resin is copolymer, any co-polymers such as random co-polymer or block co-polymer can be used if the thermoplastic resin is co-polymer.

The thermoplastic resin is preferably a polyolefin-based resin in view of characteristics such as mechanical strength, heat resistance characteristics, chemical resistance characteristics, and the like, and molding characteristics such as ease of molten thermal molding.

The polyolefin-based resin suitably includes a type of resin that exhibits a shoulder on the high molecular weight side and a wide molecular weight distribution, a weakly cross linked type resin (resin of a type that is slightly cross linked), a long chain branching type resin, or the like.

In particular, the polyolefin-based resin preferably includes a polyolefin-based resin that exhibits a melt tension (temperature: 210 degrees C., a rate of pulling: 2.0 m/min, capillary: φ1 mm×10 mm) of 3 to 50 cN (preferably, 8 to 50 cN).

The thermoplastic resin preferably includes a rubber component and/or a thermoplastic elastomer component. This allows to achieve shape recovery after compression and flexibility during high compression, that is to say, a large deformation is enabled and the reverse deformation can be prevented. Further, since the rubber component and the thermoplastic elastomer component have a glass-transition temperature of no more than room temperature (e.g., no more than 20 degrees C.), superior flexibility and tracking characteristics can be exhibited when configured as a resin foam.

There is no particular limitation in relation to the rubber component and the thermoplastic elastomer component if they have rubber elasticity and are foamable. Examples thereof include crude rubber or synthetic rubber such as crude rubber, polyisobutylene, polyisoprene, chloroprene, butyl rubber, nitrile butyl rubber; olefin elastomer such as ethylene-propylene copolymer, ethylene-propylene-diene copolymer, ethylene-vinyl acetate copolymer, polybutene, and chlorinated polyethylene; styrene elastomer such as styrene-butadiene styrene copolymer, styrene-isoprene-styrene copolymer and hydrogenated product thereof; polyester elastomer; polyamide elastomer; polyurethane elastomers and other various thermoplastic elastomers.

They can be used alone or in combination.

Of these, the rubber component and/or a thermoplastic elastomer component is preferably an olefin-based elastomer. The olefin-based elastomer is compatible with the polyolefin-based resins that have been given as an example of a thermoplastic resin.

The olefin-based elastomer can be a type that exhibits a micro-phase separated structure in relation to a resin component A (olefin-based resin component A) and a rubber component B, can be a type in which the resin component A and the rubber component B are physically dispersed, or can be a type in which the resin component A and the rubber component B are dynamically and thermally processed in the presence of a cross linking agent (Olefinic Thermoplastic Vulcanizates dynamically cross-linked thermoplastic elastomer, TPV). Of those configurations, the olefin-based elastomer is preferably a dynamically cross-linked thermoplastic olefin-based elastomer (TPV).

The dynamically cross-linked thermoplastic olefin-based elastomer exhibits a higher coefficient of elasticity and a smaller compression permanent deformation than TPO (non-cross linked thermoplastic olefin-based elastomer). In this manner, excellent recovery characteristics can be exhibited when configured as a resin foam.

As described above, the dynamically cross-linked thermoplastic olefin-based elastomer is a multi-phase polymer having a sea/island structure that is formed by performing dynamic thermal processing in the presence of a cross linking agent of a mixture of a resin component A that forms a matrix (olefin-based resin component A) and a rubber component B that forms a domain, and then finely dispersing the cross linked rubber particles as a domain (island phase) in the resin component A that is a matrix (sea phase).

This type of dynamically cross-linked thermoplastic olefin-based elastomer includes ones described in JP2000-007858A, JP2006-052277A, JP2012-072306A, JP2012-057068A, JP2010-241897A, JP2009-067969A and JP2003/002654A, and commercially available elastomers such as Zeotherm™ produced by Zeon Corporation, THERMORUN™ produced by Mitsubishi Chemical Corporation, and SARLINK 3245D produced by TOYOBO Co., Ltd.

When the rubber component and/or the thermoplastic elastomer component are included, the weight ratio of the thermoplastic resin and the rubber component and/or thermoplastic elastomer component is preferably 10/90 to 90/10, more preferably 20/80 to 80/20, still more preferably 70/30 to 70/30, further still more preferably 60/40 to 30/70 especially preferably 50/50 to 30/70.

The foam layer of the present invention can further contain nucleating agents, flame retardants, aliphatic compounds, lubricants, shrinkage inhibitors, anti-aging agent, heat stabilizer, light resistance agents such as HALS, weather resistance agents, metal deactivators, UV absorbers, light stabilizers, stabilizers such as a copper inhibitor, antibacterial agent, antifungal agent, dispersing agent, tackifier, colorant such as carbon black, organic pigments, fillers within ranges not impeding of the effects of the present invention, in addition to the above thermoplastic elastomer, the rubber component and/or the thermoplastic elastomer component. The additive can be used alone or in combination of two or more.

Examples of the nucleating agent include oxides, complex oxides, metal carbonates, metal sulfates, metal hydroxide such as talc, silica, alumina, titanium oxide, mica; carbon particles. The nucleating agents are used alone or in a combination of two or more.

The content of the nucleating agent is preferably from 0.5 to 150 parts by weight to 100 parts by weight of the constituent foam laminate.

Example of the flame retardant include an inorganic fire retardant that is non-halogen-non-antimony based, such as. a metal hydroxide, and a hydroxide of metal compound.

The content of the flame retardant is preferably from 5 to 70 parts by weight to 100 parts by weight of the constituent foam laminate.

The aliphatic compound preferably is at least one aliphatic compound having a polar functional group and a melting point of 50 to 150 degrees C., and selected from a fatty acid, a fatty amide, and a fatty acid metal soap. Of those substances, a fatty acid and a fatty amide are preferred. In view of reducing the molding temperature during molding or foaming of the resin composition, inhibiting deterioration of the resin and of imparting sublimation resistance, the melting point of such aliphatic compound is preferably 50 to 150 degrees C.

The fatty acid is a fatty acid preferably having about 18 to 38 carbon atoms, more preferably behenic acid, and the like. The fatty amide is a fatty amide preferably having about 18 to 38 carbon atoms, more preferably erucamide. Examples of a fatty acid metallic soap include a salt of the above fatty acid, such as aluminum, calcium, magnesium.

The content of aliphatic compound is preferably 1 to 5 parts by weight to 100 parts by weight of the constituent foam laminate.

Examples of the lubricants include hydrocarbon lubricants such as liquid paraffins, paraffin waxes, microcrystalline waxes, and polyethylene waxes; ester lubricants such as butyl stearate, stearic acid monoglyceride, pentaerythritol tetrastearate, hydrogenated castor oil, and stearyl stearate.

The foam layer of the present invention can be manufactured using any method that is a known method in this technical field. In particular, a method for manufacture by use of high pressure gas as a foaming agent is preferred in light of facilitating production of a foam that has a high cell density and a low cell diameter. Of such methods, the method using a high pressure inert gas as the foaming agent is preferable, and using a gas in a supercritical state is more preferable. Examples of such method include a method described in JP2007-291337A, JP2008-88283A, JP2009-91556A and JP2011-12235A.

In particular, a method includes a batch method in which, after a resin composition is preformed into a suitable shape such as a sheet and configured as a non-foam resin molded body (non-foam resin molded article), high pressure gas is impregnated into the non-foam resin molded body and foaming is performed by release of pressure, and a continuous method in which a resin composition is kneaded with a high pressure gas under application of pressure, the pressure is released at the same time as molding, and molding and foaming are performed at the same time.

When molding or foaming a resin composition in a batch method, a method that forms a non-foam resin molded body for foaming includes for example, a method in which a resin composition is molded using a kneading machine such as a single screw extruder, a twin screw extruder, and the like; a method in which a resin composition is uniformly kneaded using a kneading machine such as a roller, cam, kneader, a Banbury type blade or the like, and is pressed and molded to a predetermined thickness using a hot plate press; a method that molds the resin composition by use of an injection molding machine, or the like.

In addition, the non-foam resin molded body can also formed by another molding method in addition to extrusion molding, press molding, or injection molding.

Furthermore, there is no particular limitation in relation to the shape of the non-foam resin molded body. Various shapes can be selected in response to a given use, and for example includes a sheet configuration, a roll configuration, a tabular configuration, an agglomerated configuration, or the like.

In this manner, when molding or foaming the resin composition in a batch method, it is possible to mold the resin composition using a suitable method to thereby obtain a non-foam resin molded body having a desired thickness and shape.

When molding or foaming the resin composition in a batch method, foam is formed in the resin by passing through a gas impregnation step of placing the resulting non-foam resin molded body in a pressure-resistant vessel (high-pressure vessel), introducing high pressure gas (in particular, an inert gas, and furthermore carbon dioxide), and impregnating the high pressure gas into the non-foam resin molded body, a pressure reduction step of releasing the pressure (usually to atmospheric pressure) when the high pressure gas is sufficient impregnated to cause the production of cell nuclei in the resin, and in some cases (when required), a heating step in which the cell nuclei are formed by heating. The cell nuclei can be grown at ambient temperature in the event that a heating step is not provided.

When molding or foaming the resin composition in a continuous method, foaming or molding is performed by a kneading and impregnation step in which the resin composition is kneaded by use of extruding device such as a single screw extruding device or double screw extruding device, high pressure gas (in particular, an inert gas, and furthermore carbon dioxide) is introduced, and the high pressure gas is fully impregnated into the resin composition, and a molding and pressure reduction step in which the pressure is released (usually to atmospheric pressure) by extruding the resin composition through a die or the like provided on the distal end of the extruding device, and performing molding and foaming at the same time.

In the kneading and impregnation step and the molding and pressure reduction step, use of an injection molding device is possible in addition to use of an extruding device. Furthermore, when foaming or molding the resin composition in a continuous method, a heating step can be provided as required in order to grow the cells by heating.

When using either the continuous method or batch method, after growing cells, rapid cooling can be performed by application of cold water as required, to thereby solidify a shape. Furthermore, the introduction of high pressure gas can be performed continuously or discontinuously.

A method of heating when growing the cell nuclei includes application of a known method such as a water bath, oil bath, heated roller, heated air oven, far infrared, near infrared, microwave, or the like.

When manufacturing the resin foam of the present invention, it is preferred to perform stretching during the above steps or after performing the above steps in order to produce a stable foam in an efficient manner.

The stretching operation is preferably performed so that the ratio of the extrusion speed and the molding speed the resin is 1:1.2 to 5.

When the stretching operation falls within the above range, it is possible to prevent instability in feeding of the resin sheet by reason of the frictional resistance of the roll or belt, and thereby avoid crushing the thickness direction as a result of excess stretching. As a result, it is possible to ensure porosity, cushioning characteristics, and flexibility.

When the resin contains a large amount of the rubber component and/or thermoplastic elastomer component, although it is normally the case that sliding with respect to the belt or roll decreases, when the stretching falls within the above range, stable feeding of the sheet is enabled irrespective of the resin composition, and it is possible to obtain a resin foam with a stable shape.

As used herein, molding speed denotes the speed of feeding the resin sheet by the belt or roll. There is no particular limitation on the molding speed, and for example is preferably 2 to 100 m/min. In this manner, stable molding of the resin sheet is enabled and thereby production efficiency can be maintained.

Furthermore, when the resin sheet is nipped by means of a belt or roll, the nip pressure is preferably of a degree that does not cause the foam to collapse in the thickness direction.

There is no particular limitation to the mixing amount of gas when foaming or molding the resin composition, and for example, is preferably 2 to 10 parts by weight, and more preferably is 2.5 to 8 parts by weight relative to the total amount of the resin component in the resin composition. When in that range, foam with a high expansion speed can be obtained without separation of the gas in the molding device.

The pressure when impregnating gas into the non-foam molded body or the resin composition, in the gas impregnation step in a batch method, and in the kneading and impregnation step in a continuous method during foaming and molding the resin composition in relation to the resin foam of the present invention is suitably selected in consideration of the type of gas or operation characteristics. For example, when the gas is an inert gas, and in particular when it is carbon dioxide, the pressure is at least 6 MPa (for example 6 to 100 MPa), preferably at least 8 MPa (for example 8 to 100 MPa).

When the pressure has the above setting, the gas content amount coincides with a suitable amount, the cell nuclei formation speed can be controlled and the number of formed cell nuclei can be adjusted to a suitable number. Furthermore, the cell growth during foaming can be suitably controlled and it is possible to adjust the cell diameter to a small value. That is to say, control of the cell density and the cell diameter is facilitated. As a result, a superior dust resistance effect can be imparted.

The temperature when impregnating high pressure gas into the non-foam molded resin body or the resin composition in the kneading and impregnation step in a continuous method or the gas impregnation step in a batch method during foaming and molding the resin composition can be suitably adjusted in response to the type of gas or resin that is used. For example, when operation characteristics are taken into account, the temperature is 10 to 350 degrees C.

In a continuous method, the impregnation temperature when high pressure gas is introduced and kneaded into the resin composition is preferably 60 to 350 degrees C.

When carbon dioxide is used as the high-pressure gas, the impregnation temperature is preferably 32 degrees C. or higher, and more preferably 40 degrees C.

The decompression in the decompression step in a batch method or in a continuous method during foaming and molding the resin composition is preferably performed at a decompression speed of from 5 to 300 MPa/second, for obtaining more uniform fine cells. The heating in the heating step can be performed at a temperature of typically from 40 degrees C. to 250 degrees C., and preferably from 60 degrees C. to 250 degree C.

The method of manufacturing the foam laminate of the present invention is preferably a method in which, after the foam layer is formed, the layer containing a polyolefin-based resin is laminated onto one surface of the foam layer.

The method of forming the layer containing a polyolefin-based resin itself includes use of a method that is known in this technical field. For example, the material composition that configures the layer containing a polyolefin-based resin can be formed by coating directly onto the resulting foam layer by use of a suitable method such as a knife coater, roller coater, a gravure coater, a die coater, a reverse coater, or the like.

For example, the material composition that configures the layer that includes the polyolefin resin can be coated and formed onto a suitable casting process sheet (peeling liner) such as a film or the like that is Anti-sticking treated on the surface, and then the material composition can be molded by a method of transferring onto the foam layer. In the latter configuration, a method is preferred in which during transfer, a liquid adhesive or the like can be used for adhesion processes, and the material composition on the peeling liner is coated at least at the melting temperature of the material composition, and prior to completely leaving a molten state, that is to say, prior to losing adhesive characteristics, becomes adhered to the foam layer without use of an adhesive or the like.

Furthermore, manufacture can be performed by use of a method of co-extrusion in which the material that configures the foam layer and the material that configures the layer containing a polyolefin-based resin are respectively adjusted to a suitable temperature in an extrusion device, subjected to confluent lamination in a die and co-extruded from the die lips. In this configuration, the material that configures the foam layer is caused to foam and thereby configure the foam layer, and the layer that is formed from a material that configures the layer containing a polyolefin-based resin is laminated in a configuration in which the surface layer is the foam layer. The die used at the distal end of the extrusion device in this configuration includes a flat die, annular die, or the like.

In this manner, between the layer containing a polyolefin-based resin and the foam layer, a layer is provided in which a portion of both those layers is melted or mixed, and thereby lamination of those layers can be integrally or completely performed. As a result, it is possible to prevent peeling at the interface of the layer containing a polyolefin-based resin and the foam layer.

An adhesive for constituting the adhesive layer is not limited when the foam laminate of the present invention has an adhesive layer, and can be suitably chosen from among known adhesives such as acrylic adhesives, rubber adhesives (e.g., crude rubber adhesives and synthetic rubber adhesives), silicone adhesives, polyester adhesives, urethane adhesives, polyamide adhesives, epoxy adhesives, vinyl alkyl ether adhesives, and fluorine-containing adhesives. The adhesive can be used alone or in combination of two or more. The adhesives can be adhesives of any type, such as emulsion adhesives, solvent-borne adhesives, hot-melt adhesives, oligomer adhesives, and solid adhesives. Of such adhesives, acrylic adhesives are preferred from the viewpoint typically of preventing contamination to the adherend.

The adhesive layer has a thickness of from 2 to 100 micrometer, and preferably from 10 to 100 micrometer. The thickness of the adhesive layer is preferably minimized, because such a thin pressure-sensitive adhesive layer can be more effectively prevented from the attachment of dirt or dust at the edges thereof.

The adhesive layer can have a single-layer structure or multilayer structure, and a foaming layer or non-foaming layer. Of these, the adhesive layer is preferably a non-foaming adhesive layer. The adhesive layer can be provided by way of another layer (lower layer). Such lower layer includes for example another adhesive layer, an intermediate layer, a primer layer, a substrate layer (in particular, a film layer, non-woven material layer, or the like), or the like. The lower layer can be a foam layer, or a porous layer, and is preferably a non-foam layer, and more preferably resin layer.

The adhesive layer can be protected by a peelable film (separator) (for example, peelable paper, peelable film, or the like).

The foam material of the present invention finds suitable application as a member used when mounting (attaching) various members or components, for example, a component that configures an electrical or electronic device, and for example can be applied as a dust preventing member, sealing member, impact absorption member, sound insulating member, cushioning material, waterproof material or the like. The components that configure an electrical or electronic device more specifically include an image display member (display unit) (in particular a small image display unit) that is mounted on an image display device such as a liquid crystal display, an electroluminescence display, a plasma display, or the like, and include an optical member or an optical component such as a lens and camera (in particular a small camera or lens) that is mounted to a device configured for mobile communication such as, so-called, a “mobile telephone”, “mobile information terminal”, or the like.

A suitable configuration for use of the foam laminate of the present invention, for example, includes a component used by insertion between a display unit and housing (window) of a liquid crystal display (LCD), or a display unit peripheral such as a liquid crystal display (LCD) for the purpose of preventing water or dust, shielding light, cushioning, or the like.

The foam laminate of the present invention, when mounted on this type of member or component, preferably is mounted to cover a clearance of the member or component. There is no particular limitation for the clearance that for example can be about 0.05 to 0.5 mm.

A suitable configuration for use of the foam laminate of the present invention, for example, includes a component used by insertion between a display unit and housing (window) of a liquid crystal display (LCD), or a display unit peripheral such as a liquid crystal display (LCD) for the purpose of preventing water or dust, shielding light, cushioning, or the like.

In view of this, examples of the electrical or electronic devices using the repeelable foam laminate in relation to an electronic device of the present invention described above include devices having an image apparatus such as a liquid crystal display, an electroluminescence display, a plasma display, and the like, and more specifically include a device configured for mobile communication such as, a mobile telephone, mobile information terminal, camera, CCD device, and the like.

The foam material and resin foam of the present invention will be described below making reference to the examples.

### Example 1

### Formation of Foam Layer

As the resin composition,

50 parts by weight of a polypropylene [melt flow rate (MFR): 0.35 g/10 min],

55 parts by weight of a polyolefin elastomer [melt flow rate (MFR): 6 g/10 min, JIS A-hardness: 79],

5 parts by weight of ercamide (NEWTRON S, manufactured by Nippon Fine Chemical,

6 parts by weight of carbon black (bland name “Asahi #35” manufactured by Asahi Carbon Co. ltd.)

10 parts by weight of powdered Magnesium hydroxide as a flame retardant (average particle diameter: 0.7 micrometer) were kneaded at a temperature of 200 degrees C. using twin screw kneader manufactured by Japan Steel Works, LTD.

Thereafter, the resin component was extruded into a strand shape, cooled with water and formed into pellets. The obtained pellet had a softening temperature of 155 degrees C.

The pellets were placed into a single-screw extruder manufactured by Japan Steel Works LTD., and carbon dioxide gas was introduced under a pressure of 22 (after introduction 19) MPa in an atmosphere at 220 degrees C. The carbon dioxide gas was allowed sufficiently to saturate and to cool to a temperature at which the gas was suitable for foaming operations. Then, extrusion was performed from a die, and the ratio of the resin extrusion speed and the molding speed was adjusted to be in the range of 1:1.2 to 2 to thereby obtain a foam in the form of semiclosed- and semiopen-cell structure.

The foam had an apparent density of 0.05 g/cm³, and a thickness of 2.0 mm. The foam was sliced to thereby obtain a foam layer X of 0.5 mm thick.

### Formation of Foam Laminate

The resin compositions that configure the layer containing a polyolefin-based resin:

15 parts by weight of a polypropylene elastomer (Taftheren H5002, manufactured by Sumitomo Chemical. Co. Ltd.),

70 parts by weight of a polypropylene wax (Licocene PP1602, manufactured by Clariant Co., Ltd),

10 parts by weight of a polypropylene wax (Hi-WAX NP055, manufactured by Mitsui Chemicals, Inc., and

5 parts by weight of a saturated alicyclic hydrocarbon compound (ARKON P125, manufactured by Arakawa Chemical Industries, Ltd.) were placed into a Laboplasto Mill manufactured by Toyo Seiki Seisaku-Sho Ltd, and kneaded at a rotation speed of 30 rpm for five minutes at 140 degrees C. Thereafter, the temperature was increased to 200 degrees C. and kneading was performed for 10 minutes. The resulting mixture was coated to a thickness of 30 micrometers onto a peeling liner (MRF38 manufactured by Mitsubishi Plastics Inc.) using a GPD-300 (manufactured by Yuriroll Co. Ltd.) at a melting temperature of 200 degrees C.

After coating, prior to loss of adhesive characteristics due to cooling of the resin composition, a foam laminate was formed by transferring and adhering onto the resulting foam layer X.

The crystal melting energy of the layer containing a polyolefin-based resin was 41.3 J/g.

### Example 2

### Formation of Foam Laminate

As the resin compositions that configure the layer containing a polyolefin-based resin,

15 parts by weight of a polypropylene elastomer (Notio PN3560, manufactured by Mitsui Chemicals, Inc),

70 parts by weight of a polypropylene wax (Licocene PP2602, manufactured by Clariant Inc.),

10 parts by weight of a polypropylene wax (Hi-WAX NP055, manufactured by Mitsui Chemicals, Inc, and

5 parts by weight of a hydrogenated petroleum resin (I-MARV P125, manufactured by Idemitsu Kosan Co. Ltd.), were placed into a Laboplasto Mill manufactured by Toyo Seiki Seisaku-Sho Ltd, and kneaded at a rotation speed of 30 rpm for five minutes at 140 degrees C. Thereafter, the temperature was increased to 200 degrees C. and kneading was performed for 10 minutes. The resulting mixture was coated to a thickness of 30 micrometers onto a peeling liner (MRF38 manufactured by Mitsubishi Plastics Inc.) using a GPD-300 (manufactured by Yuriroll Co. Ltd.) at a melting temperature of 200 degrees C.

After coating, prior to loss of adhesive characteristics due to cooling of the resin composition, a foam laminate was formed by transferring and adhering onto the resulting foam layer X.

The crystal melting energy of the layer containing a polyolefin-based resin was 43.1 J/g.

### Example 3

### Formation of Foam Laminate

As the resin compositions that configure the layer containing a polyolefin-based resin,

10 parts by weight of a polypropylene elastomer (Notio PN3560, manufactured by Mitsui Chemicals, Inc),

70 parts by weight of a polypropylene wax (Licocene PP2602, manufactured by Clariant Inc.),

10 parts by weight of a polypropylene wax (Hi-WAX NP055, manufactured by Mitsui Chemicals, Inc, and

10 parts by weight of a saturated alicyclic hydrocarbon compound (ARKON P125, manufactured by Arakawa Chemical Industries, Ltd.), were placed into a Laboplasto Mill manufactured by Toyo Seiki Seisaku-Sho Ltd, and kneaded at a rotation speed of 30 rpm for five minutes at 140 degrees C. Thereafter, the temperature was increased to 200 degrees C. and kneading was performed for 10 minutes. The resulting mixture was coated to a thickness of 30 micrometers onto a peeling liner (MRF38 manufactured by Mitsubishi Plastics Inc.) using a GPD-300 (manufactured by Yuriroll Co. Ltd.) at a melting temperature of 200 degrees C.

After coating, prior to loss of adhesive characteristics due to cooling of the resin composition, a foam laminate was formed by transferring and adhering onto the resulting foam layer X.

The crystal melting energy of the layer containing a polyolefin-based resin was 38.4 J/g.

### Comparative Example 1

With the exception that the release liner was changed to 75ESP(M) cleam-revised (Oji Specialty Paper Co., Ltd.), a foam laminate was formed in the same manner as the above.

### Comparative Example 2

The foam layer X obtained in Example 1 was attached with a double-faced adhesive tape of 30 micrometer thick (No. 5603 manufactured by Nitto Denko Corporation) on one surface.

### Comparative Example 3

The foam layer X obtained in Example 1 was used without modification.

### Evaluation Method

The characteristics of the foam laminates were evaluated with reference to the method below.

### Evaluation of Water Resistance

In the foam laminate obtained in the Examples and Comparative Example 1, a double-sided adhesive tape (No. 5603 manufactured by Nitto Denko Corporation) with a thickness of 30 micrometers was adhered onto the surface that was opposite to the side on which the layer containing a polyolefin-based resin was laminated. A double-sided adhesive tape (No. 5603 manufactured by Nitto Denko Corporation) with a thickness of 30 micrometers was adhered in the same manner to one surface of the foam layer (that is to say, the surface opposite the side used for evaluation of water resistance) obtained in Comparative Examples 2 and 3.

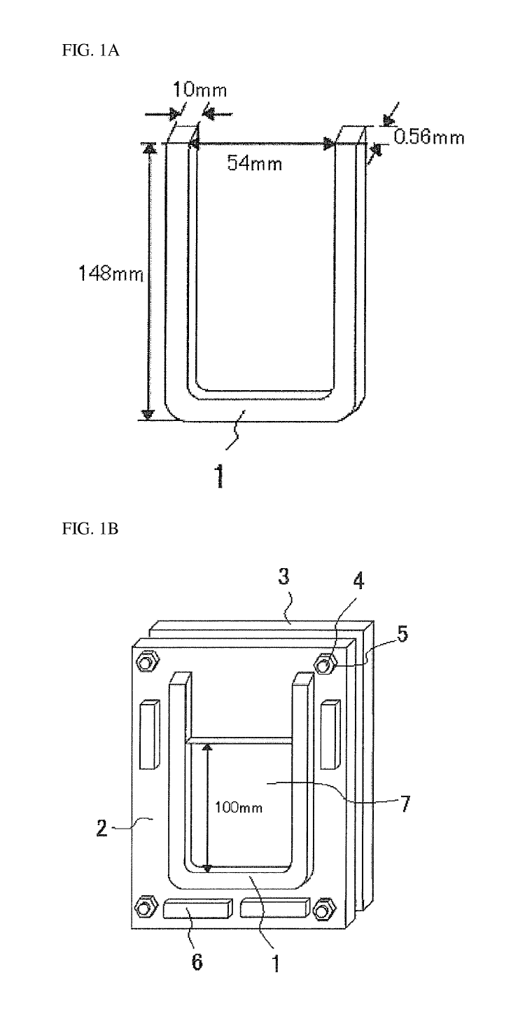

Thereafter, the foam laminates or foam layers as illustrated in FIG. 1A were punched into a U shape having a width of 10 mm, height of 148 mm, and interval between both distal ends of 54 mm to thereby obtain evaluation sample 1.

As illustrated in FIG. 1B, evaluation sample 1 that has been punched into a U shape was configured with the layer containing a polyolefin-based resin attached to an acrylic plate 2, the foam layer attached to an aluminum plate 3. A bolt 4 and a nut 5 were used to compress the acrylic plate 2 and the aluminum plate 3 by 60% in the thickness direction. The adjustment of the thickness was performed by use of a spacer 6.

Thereafter, water 7 was provided to a height of 100 mm in the U-shaped evaluation sample 1, and the time until leakage of water was measured.

### Reworking Evaluation

The water was removed from those evaluation samples that did not exhibit water leakage in the water resistance evaluation, and the device was disassembled to confirm whether the evaluation sample can be peeled from the acrylic plate without fracture.

### Surface Roughness Measurement

An LEXT OLS400 (manufactured by Olympus Corporation) was used to evaluate surface roughness Sa of the polyolefin layer with reference to a surface area range of 2.5 mm×2.5 mm.

### Shear Adhesive Strength

The foam layer side of the evaluation sample was backed using an adhesive tape (NO. 31B manufactured by Nitto Denko Corporation), and cut into 20 mm×100 mm.

After punching, the separator was peeled, and the surface of the layer containing a polyolefin-based resin was pressed using a single complete stroke with a roller having a weight of 2 kg onto an acrylic plate that has been washed in ethanol.

A section 10 mm from the end of the acrylic plate was cut, and stretched in a shearing direction at 0.3 m/min for 30 minutes after pressing to thereby measure the force at peeling or fracturing of the sample.

### 180 Degree Adhesive Strength

The foam laminate was cut with a width of 20 mm and length of 100 mm to form an evaluation sample.

The evaluation sample was pressed using a single complete stroke with a roller having a weight of 2 kg onto an acrylic plate (trade name “Acrylite” manufactured by Mitsubishi Rayon Co. Ltd.), adhered into place, and left for 30 minutes at ambient temperature (23 degrees±2 degrees C.)

After 30 minutes elapses, a peel test (JIS Z 0237:2009) was performed using a tensile strength testing device (“TG-1 kN” manufactured by Minebea Co. Ltd) under conditions of temperature: 23 degrees±2 degrees C., humidity of 50±5% RH, speed of pulling: 0.3 m/min, peel angle: 180 degrees to thereby measure the adhesive strength in relation to the acrylic plate.

TABLE 1

| | Examples | | | Comparative Examples | | |
|---|---|---|---|---|---|---|
| | 1 | 2 | 3 | 1 | 2 | 3 |
| Time until | No | | | Leaked | No | Leaked |
| Leakage | leakage | | | after | leakage | after |
| | after | | | 1 week | after | 1 min. |
| | 1 week | | | | 1 week | |
| Reworking | No | | | — | Presence | — |
| | adhesive | | | | of adhesive | |
| | residue | | | | residue | |
| Surface | 6.4 | 6.9 | 5.9 | 14.5 | — | — |
| Roughness | | | | | | |
| Sa (μm) | | | | | | |
| Shear Adhesive | 30 | 33 | 38 | 0 | 47 | — |
| Strength (N/ | | | | | | |
| 20 mm*10 mm) | | | | | | |
| 180 Degree | 0.38 | 0.38 | 0.46 | 0 | 4.28 | — |
| Adhesive | | | | | | |
| Strength | | | | | | |
| (N/20 mm) | | | | | | |

### SEM Observation

A cross section of the example was observed using a scanning electron microscope (SEM). An S-3400N manufactured by Hitachi High-Technologies Corporation was used as the scanning electron microscope.

As a result, the surface of the foam layer in both of the examples was confirmed to be covered by the surface layer containing a polyolefin, and the cells were substantially completed blocked.

On the other hand, the surface of the foam layer was confirmed to block the cell orientation as a partially fused layer.

### Crystal Melting Energy

The crystal melting energy of the examples above was measured as shown below.

A sample of 3.0 mg was taken from the layer containing a polyolefin-based resin and used as a test sample.

The test sample was subjected to a differential scanning calorimetry measurement (DSC measurement) under the following conditions in compliance with JIS K 7122:1987 to thereby obtain a DSC curve.

The total of the fusion energy during 2nd Run heating was calculated to thereby find the crystal melting energy.

### DSC Measurement Conditions

Amount of sample: 3.0 mg

Pan: Tzero pan (manufactured by TA Instruments) (diameter 4 mm), Tzero lid (manufactured by TA Instruments)

Speed of Temperature Increase: 10 degrees C/min

Speed of Temperature Decrease: 10 degrees C/min

### Temperature Conditions

1st Run heating (first heating): temperature increase from −50 degrees C. to 200 degrees C.

1st Run cooling (first cooling): temperature decrease from 200 degrees C. to −50 degrees C.

2nd Run heating (second heating): temperature increase from −50 degrees C. to 200 degrees C.

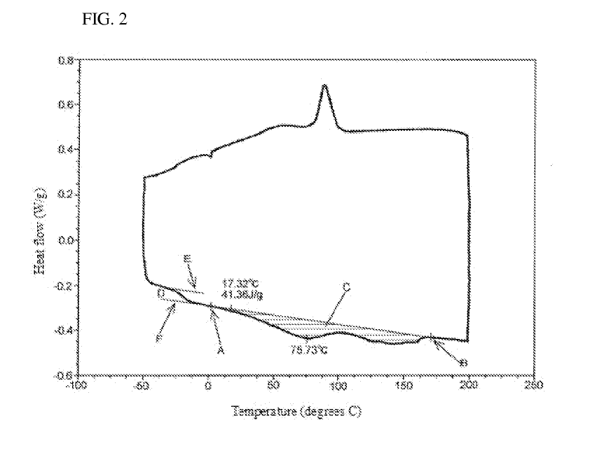

More specifically, firstly, a sample of Example 1 was subjected to an increase in temperature from −50 degrees C. to 200 degrees C. by heating at a temperature increase speed of 10 degrees C/min, and caused to melt. Then, the melted sample was cooled using a temperature decrease speed of 10 degrees C/min so that the temperature falls from 200 degrees C. to −50 degrees C. and the sample solidifies. The solidified sample was re-subjected to an increase in temperature from −50 degrees C. to 200 degrees C. by heating at a temperature increase speed of 10 degrees C/min, and caused to melt. Then, a DSC curve was obtained by performing a differential scanning calorimetry measurement (DSC measurement) (refer to FIG. 2).

The crystal melting energy was obtained from the resulting DSC curve as the surface area (surface area of the peak of the inclined line in FIG. 2) of the portion enclosed by the melt peak, and the straight line obtained by connecting the point of separation (point A in FIG. 2) from the base line about the melt peak (peak C in FIG. 2 (the peak in the inclined portion of FIG. 1)), and the point (point B in FIG. 2) that returns to the base line.

The base line of the melt peak was the high temperature side base line (base line F) of the low temperature base line (base line E in FIG. 2) and the high temperature base line (base line F in FIG. 2) when the glass transition temperature was determined with reference to the step-like variation portion (the step-like variation portion D in FIG. 2) of the DSC curve.

In Examples 2 and 3, the same DSC curve as that described above was obtained to thereby measure the crystal melting energy.

### INDUSTRIAL APPLICABILITY

The present invention is a foam laminate that exhibits a high expansion rate and superior strain recovery characteristics and cushioning characteristics, and that are useful in relation to internal insulation of electronic equipment and the like, damping materials, sound insulation materials, dust-proofing materials, shock absorbing materials, light shielding materials, and insulating materials, food packaging materials, clothing materials, building materials, or the like. In particular, the present invention finds wide application in electronic device of display unit peripherals such as mobile telephones, mobile information terminals, LCDs or the like as a repeelable foam laminate.

### REFERENCE SIGNS LIST

1 evaluation samples
2 acryl board
3 aluminum board
4 bolt
5 nut
6 spacer
7 water

1. A repeelable foam laminate for use of an electronic device being configured as a structure in which a layer containing a polyolefin-based resin is laminated to at least one surface of a foam layer, and
surface roughness Sa of the layer containing a polyolefin-based resin is no more than 10 micrometers.

2. The repeelable foam laminate for use of an electronic device according to claim 1, wherein apparent density of the foam layer is 0.02 to 0.20 g/cm³, and
180-degree adhesive strength of the layer containing a polyolefin-based resin is no more than 1.0 N/20 mm with respect to an acrylic plate, and
shear adhesive strength is at least 5 N/20×10 mm.

3. The repeelable foam laminate for use of an electronic device according to claim 1, wherein the layer containing a polyolefin-based resin does not deform in an atmosphere of 100 degrees C.

4. The repeelable foam laminate for use of an electronic device according to claim 1, wherein the crystal melting energy of the layer containing a polyolefin-based resin is no more than 50 J/g.

5. The repeelable foam laminate for use of an electronic device according to claim 1, wherein the polyolefin-based resin is an olefin-based resin containing a structural unit derived from propylene.

6. An electronic or electrical device being used the repeelable foam laminate for use of an electronic device according to claim 1.
